(19) United States
(12) Patent Application Publication
(10) Pub. No.: US 2022/0067594 A1
(43) Pub. Date: Mar. 3, 2022

(54) INFORMATION PROCESSING APPARATUS, METHOD, AND SYSTEM

(71) Applicant: TOYOTA JIDOSHA KABUSHIKI KAISHA, Toyota-shi Aichi-ken (JP)

(72) Inventors: Tae Sugimura, Miyoshi-shi Aichi-ken (JP); Kenta Miyahara, Toyota-shi Aichi-ken (JP); Shin Sakurada, Toyota-shi Aichi-ken (JP); Joshua Babcock, Dallas, TX (US)

(73) Assignee: TOYOTA JIDOSHA KABUSHIKI KAISHA, Toyota-shi Aichi-ken (JP)

(21) Appl. No.: 17/459,099

(22) Filed: Aug. 27, 2021

(30) Foreign Application Priority Data
Aug. 31, 2020 (JP) 2020-146256

(51) Int. Cl. G06Q 10/02; G06Q 30/02; G01C 21/34; B60W 40/08; G01C 21/36

(52) U.S. Cl. CPC G06Q 10/02; G06Q 30/0201; G06Q 50/30; B60W 40/08; G01C 21/3626; G01C 21/3407

(57) ABSTRACT

An information processing apparatus includes a controller configured to identify each passenger in a plurality of passengers on board a vehicle based on information on the plurality of passengers, select at least two facilities from among a plurality of facilities based on user attributes indicating attributes of each passenger in the plurality of passengers, notify the plurality of passengers of the at least two facilities, and select one facility from among the at least two facilities based on a response from each passenger in the plurality of passengers.

### CROSS-REFERENCE TO RELATED APPLICATION

This application claims priority to Japanese Patent Application No. 2020-146256, filed on Aug. 31, 2020, the entire contents of which are incorporated herein by reference.

### TECHNICAL FIELD

The present disclosure relates to an information processing apparatus, a method, and a system.

### BACKGROUND

Technology for selecting one facility from among a plurality of facilities is known. For example, Patent Literature (PTL) 1 discloses a navigation apparatus that searches for recommended facilities determined based on user preferences.

### CITATION LIST

### Patent Literature

PTL 1: JP 2014-098587 A

### SUMMARY

However, in conventional technology, for example, in a case in which preferences differ among a plurality of users on board an automobile, one suitable recommended facility cannot necessarily be selected. Therefore, there is room for improvement in technology for selecting one facility from among a plurality of facilities.

It would be helpful to improve technology for selecting one facility from among a plurality of facilities.

An information processing apparatus according to an embodiment of the present disclosure is an information processing apparatus including a controller configured to:

identify each passenger in a plurality of passengers on board a vehicle based on information on the plurality of passengers;

select at least two facilities from among a plurality of facilities based on user attributes indicating attributes of each passenger in the plurality of passengers;

notify the plurality of passengers of the at least two facilities; and

select one facility from among the at least two facilities based on a response from each passenger in the plurality of passengers.

A method according to an embodiment of the present disclosure is a method executed by an information processing apparatus, the method including:

identifying each passenger in a plurality of passengers on board a vehicle based on information on the plurality of passengers;

selecting at least two facilities from among a plurality of facilities based on user attributes indicating attributes of each passenger in the plurality of passengers;

notifying the plurality of passengers of the at least two facilities; and

selecting one facility from among the at least two facilities based on a response from each passenger in the plurality of passengers.

A system according to an embodiment of the present disclosure is a system including:

a terminal apparatus; and

a server configured to communicate with the terminal apparatus,

wherein

the terminal apparatus is configured to transmit, to the server, information on a plurality of passengers on board a vehicle,

the server is configured to:

identify each passenger in the plurality of passengers based on the information; and

select at least two facilities from among a plurality of facilities based on user attributes indicating attributes of each passenger in the plurality of passengers,

the terminal apparatus is configured to notify the plurality of passengers of the at least two facilities, and

the terminal apparatus or the server is configured to select one facility from among the at least two facilities based on a response from each passenger in the plurality of passengers.

According to an embodiment of the present disclosure, technology for selecting one facility from among a plurality of facilities is improved.

### BRIEF DESCRIPTION OF THE DRAWINGS

In the accompanying drawings:

FIG. 1 is a block diagram illustrating a schematic configuration of a system according to an embodiment of the present disclosure;

FIG. 2 is a block diagram illustrating a schematic configuration of a terminal apparatus;

FIG. 3 is a block diagram illustrating a schematic configuration of a server;

FIG. 4 is a diagram illustrating an example of a user database;

FIG. 5 is a diagram illustrating an example of a facility database; and

FIG. 6 is a flowchart illustrating operations of the system.

### DETAILED DESCRIPTION

Hereinafter, an embodiment of the present disclosure will be described.

### Summary of Embodiment

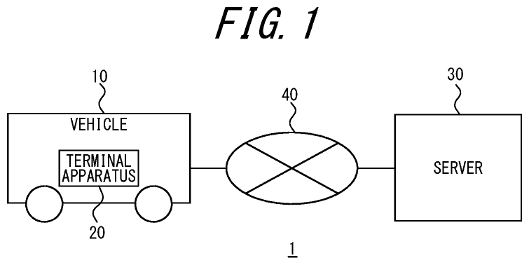

An outline of a system 1 according to an embodiment of the present disclosure will be described with reference to FIG. 1. The system 1 includes a vehicle 10, a terminal apparatus 20, and a server 30. The vehicle 10, the terminal apparatus 20, and the server 30 are communicably connected with a network 40 including, for example, a mobile communication network, the Internet, and the like.

The vehicle 10 is an automobile, for example, but is not limited to this, and may be any vehicle that a person can board. The vehicle 10 may be capable of automated driving such as any one of Level 1 to Level 5 as defined by the Society of Automotive Engineers (SAE), for example. The terminal apparatus 20 is any information processing apparatus that a user can use. For example, an in-vehicle apparatus such as a navigation apparatus, or a general purpose apparatus such as a smartphone or a personal computer (PC) that is in the user's possession may be used as the terminal apparatus 20. The server 30 includes a single information processing apparatus or multiple information processing apparatuses that can communicate with each other. The server 30 has, for example, a route guidance function of notifying, via the terminal apparatus 20, the user of guidance information on a route.

First, an outline of the present embodiment will be described, and details thereof will be described later. The server 30 identifies each passenger in a plurality of passengers on board the vehicle 10 based on information on the plurality of passengers. As will be described later, in the present embodiment, the information on the passengers is an image of the passengers. The server 30 selects at least two facilities from among a plurality of facilities based on user attributes indicating attributes of each passenger in the plurality of passengers. As will be described later, the user attributes are, for example, information indicating age, gender, and the like. Each facility in the plurality of facilities is, for example, a restaurant. The server 30 notifies the plurality of passengers of the at least two facilities via the terminal apparatus 20. Then, the server 30 selects one facility from among the at least two facilities based on a response from each passenger in the plurality of passengers. As will be described later, the selected one facility may be set as, for example, a destination in route guidance.

As described above, according to the present embodiment, at least two facilities are selected based on user attributes such as ages and genders of a plurality of passengers from among a plurality of facilities. Thus, for example, facilities possibly preferred by the passengers, such as facilities that tend to be preferred among people who have user attributes in common with the passengers, may be selected. According to the present embodiment, one facility is selected based on responses made by the plurality of passengers upon receiving notification of the at least two facilities. Thus, for example, by each passenger voting for a desired facility, one facility for which a larger number of passengers have voted may be selected. Therefore, technology for selecting one facility from among a plurality of facilities is improved in that, for example, even in a case in which preferences for facilities differ among the plurality of passengers, one facility preferred by a larger number of passengers may be selected.

Next, configurations of the system 1 will be described in detail.

(Configuration of Terminal Apparatus)

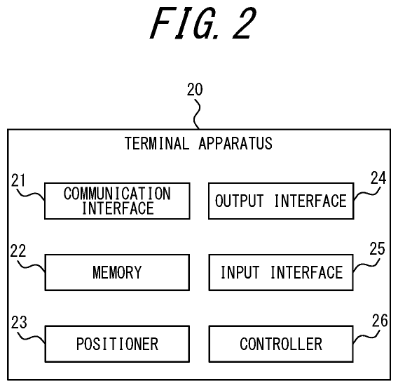

As illustrated in FIG. 2, the terminal apparatus 20 includes a communication interface 21, a memory 22, a positioner 23, an output interface 24, an input interface 25, and a controller 26.

The communication interface 21 may include at least one communication interface for connecting to the network 40. The communication interface is compliant with mobile communication standards such as the 4th generation (4G) standard and the 5th generation (5G) standard, for example, but not limited to these, and may be compliant with any communication standard. Alternatively, the communication interface 21 may include a communication interface for connecting to the network 40 via an in-vehicle communication device mounted in the vehicle 10. The communication interface is communicably connected to the in-vehicle communication device via wired or wireless communications. In the present embodiment, the terminal apparatus 20 is connected to the network 40 via the communication interface 21.

The memory 22 includes one or more memories. The memories are semiconductor memories, magnetic memories, optical memories, or the like, for example, but are not limited to these. The memories included in the memory 22 may each function as, for example, a main memory, an auxiliary memory, or a cache memory. The memory 22 stores any information used for operations of the terminal apparatus 20. For example, the memory 22 may store a system program, an application program, embedded software, and the like. The information stored in the memory 22 may be updated with, for example, information acquired from the network 40 via the communication interface 21.

The positioner 23 may include at least one device for acquiring positional information for the terminal apparatus 20. Specifically, the positioner 23 is a receiver corresponding to the Global Positioning System (GPS), for example, but is not limited to this, and may be a receiver corresponding to any satellite positioning system. Alternatively, the positioner 23 may include an interface for acquiring positional information from a receiver mounted in the vehicle 10. In the present embodiment, the positional information acquired by the positioner 23 is used as positional information for a user.

The output interface 24 may include at least one output device for outputting information to notify the user of the information. The output device is a display for outputting information as video, a speaker for outputting information as audio, or the like, for example, but is not limited to these. Alternatively, the output interface 24 may include an output interface for outputting information via an output device mounted in the vehicle 10.

The input interface 25 may include at least one input device for detecting user input. The input device is a physical key, a capacitive key, a touch screen integrally provided with a display of the output interface 24, a microphone for accepting audio input, a camera, or the like, for example, but is not limited to these. Alternatively, the input interface 25 may include an input interface for detecting user input via an input device mounted in the vehicle 10.

In the present embodiment, the input interface 25 includes a camera as an input device. The camera is capable of capturing images of a plurality of passengers on board the vehicle 10. Alternatively, the input interface 25 may include an input interface capable of communicating with a camera, such as a driving recorder, installed in the vehicle 10 so that images of the vehicle interior can be captured, and may be able to acquire images of a plurality of passengers on board the vehicle 10 from the camera.

The controller 26 includes at least one processor, at least one programmable circuit, at least one dedicated circuit, or a combination of these. The processor is a general purpose processor such as a central processing unit (CPU) or a graphics processing unit (GPU), or a dedicated processor that is dedicated to specific processing, for example, but is not limited to these. The programmable circuit is a field-programmable gate array (FPGA), for example, but is not limited to this. The dedicated circuit is an application specific integrated circuit (ASIC), for example, but is not limited to this. The controller 26 controls the operations of the entire terminal apparatus 20. Details of the operations of the terminal apparatus 20 controlled by the controller 26 will be described later. The controller 26 has a timekeeping function of keeping the current time.

(Configuration of Server)

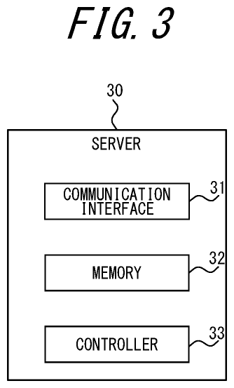

As illustrated in FIG. 3, the server 30 includes a communication interface 31, a memory 32, and a controller 33.

The communication interface 31 includes at least one communication interface for connecting to the network 40. The communication interface may be compliant with, for example, a wired local area network (LAN) standard or a wireless LAN standard. In the present embodiment, the server 30 is connected to the network 40 via the communication interface 31.

The memory 32 includes one or more memories. The memories included in the memory 32 may each function as, for example, a main memory, an auxiliary memory, or a cache memory. The memory 32 stores any information used for operations of the server 30. For example, the memory 32 may store a system program, an application program, a database, map information, and the like. The information stored in the memory 32 may be updated with, for example, information acquired from the network 40 via the communication interface 31.

In the present embodiment, the memory 32 stores a user database and a facility database.

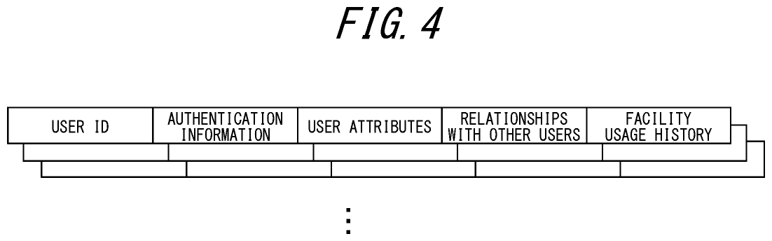

For example, as illustrated in FIG. 4, the user database includes user data having a “user ID”, “authentication information”, “user attributes”, “relationships with other users”, and a “facility usage history” for each user.

A “user ID” is information uniquely identifying a user.

“Authentication information” has any information used for authentication of a user. In the present embodiment, the authentication information has facial features of the user. Facial features are data used for face recognition processing. However, the authentication information is not limited to facial features, and may have, for example, fingerprint features, iris features, vein features, or other features. Alternatively, the authentication information may have information indicating a PIN code, a password, or the like.

“User attributes” have information indicating any attributes of a user. In the present embodiment, attributes of a user include gender, age, hometown, family structure, or a combination thereof, but are not limited to these.

“Relationships with other users” have information regarding other users who each have a predetermined relationship to a user. In the present embodiment, the “relationships with other users” have information indicating the respective user IDs of the other users and respective blood or marital relationships of the other users (e.g., husband, wife, child, parent, or the like). However, the “relationships with other users” may have, for example, information other than blood or marital relationships, such as hierarchical relationships (e.g., superior, subordinate, or the like).

A “facility usage history” has any information regarding facilities used by a user in the past. In the present embodiment, the “facility usage history” includes information indicating a facility ID, a facility attribute, and a usage date and time of each facility used by the user in the past. Facility IDs and facility attributes will be described later.

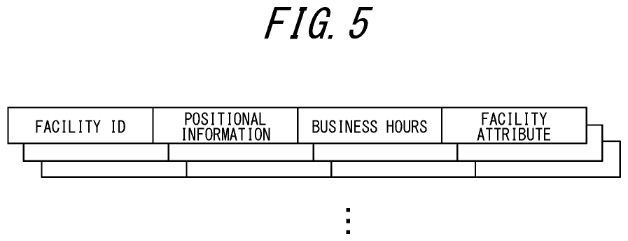

For example, as illustrated in FIG. 5, the facility database includes facility data having a “facility ID”, “positional information”, “business hours”, and a “facility attribute” for each facility.

A “facility ID” is information uniquely identifying a facility. In the present embodiment, each facility is a restaurant. However, each facility may be, for example, any facility other than a restaurant, such as a department store or a hospital.

“Positional information” is information indicating the position of a facility on a map.

“Business hours” are information indicating business hours of a facility.

A “facility attribute” is information indicating any attribute of a facility. In the present embodiment, an attribute of a facility includes information indicating the type of menu (“Japanese food”, “western food”, “Chinese food”, or the like) served by a restaurant which is the facility. However, the attribute of the facility may include, for example, any information other than the type of menu, such as a rating or an average budget of the restaurant.

The controller 33 illustrated in FIG. 3 includes at least one processor, at least one programmable circuit, at least one dedicated circuit, or a combination of these. The controller 33 controls the operations of the entire server 30. Details of the operations of the server 30 controlled by the controller 33 will be described later.

(Flow of Operations of System)

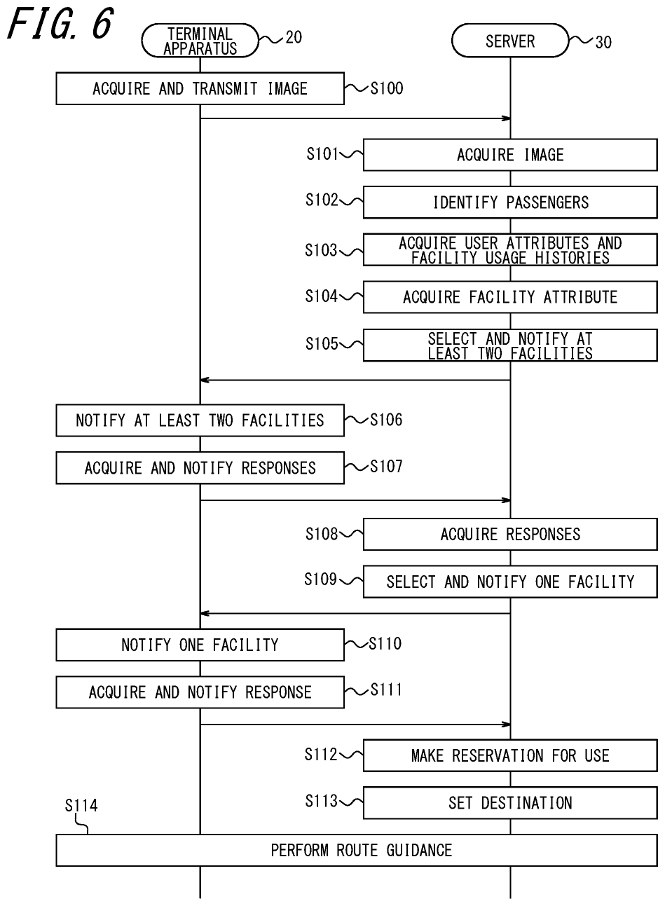

Operations of the terminal apparatus 20 and the server 30 of the system 1 will be described with reference to FIG. 6.

Step S100: The controller 26 of the terminal apparatus 20 acquires, using the input interface 25, information on a plurality of passengers on board the vehicle 10. In the present embodiment, the information on the passengers is an image of the passengers. The controller 26 transmits the image to the server 30 via the communication interface 21.

Step S101: The controller 33 of the server 30 acquires the image of step S100 from the terminal apparatus 20 via the communication interface 31.

Step S102: The controller 33 identifies each passenger in the plurality of passengers on board the vehicle 10 based on the acquired image.

Specifically, the controller 33 executes any image recognition process using the acquired image, and extracts facial features of each passenger. The controller 33 compares the extracted features with the features that are included in the authentication information in the user database stored in the memory 32, and identifies the user ID of each passenger, thereby identifying each passenger.

Step S103: The controller 33 acquires user attributes and a facility usage history of each passenger in the plurality of passengers.

Specifically, the controller 33 acquires, from the user database stored in the memory 32, the user attributes and the facility usage history corresponding to the user ID of each passenger.

Step S104: The controller 33 acquires, based on the user attributes and/or the facility usage history of each passenger, a facility attribute that matches a preference of each passenger (hereinafter, also referred to as a “facility attribute for a passenger” for simplicity).

Any method can be employed to acquire a facility attribute for a passenger. For example, the controller 33 may acquire, from the memory 32 or an external server that stores information indicating facility attributes of facilities that tend to be preferred among people for each user attribute, a facility attribute that corresponds or is similar to a user attribute of the passenger as the facility attribute for the passenger.

Alternatively, the controller 33 may acquire, with reference to the facility usage history of the passenger, a facility attribute of a facility that has been used a high number of times or with high frequency in a past predetermined period as the facility attribute for the passenger.

Alternatively, the controller 33 may acquire the facility attribute for the passenger using a machine learning model that takes the user attributes and/or the facility usage history of the passenger as input and outputs the facility attribute for the passenger.

Step S105: The controller 33 selects at least two facilities from among a plurality of facilities based on the facility attribute acquired in step S104. The controller 33 notifies the plurality of passengers of the at least two facilities via the terminal apparatus 20.

Specifically, the controller 33 selects, from the facility database stored in the memory 32, at least two facilities each of which corresponds or is similar to a facility attribute for a passenger. For example, in a case in which a facility attribute for a first passenger is “Japanese food” and a facility attribute for a second passenger is “western food”, a first restaurant whose facility attribute is “Japanese food” and a second restaurant whose facility attribute is “western food” may be selected from among a plurality of restaurants registered in the facility database. Then, the controller 33 transmits, to the terminal apparatus 20 via the communication interface 31, an instruction to notify the plurality of passengers of information on each selected facility.

The controller 33 may select the at least two facilities from among a plurality of facilities that exists within an area in the vicinity of the vehicle 10. Specifically, the controller 33 may identify, for example, a plurality of facilities that exists within a predetermined area including the current position of the vehicle 10 (e.g., a circular area of a predetermined radius centered on the vehicle 10) based on positional information for the vehicle 10 and the positional information for each facility registered in the facility database. Then, the controller 33 selects the at least two facilities from among the plurality of identified facilities.

Alternatively, the controller 33 may select the at least two facilities from among a plurality of facilities at which the vehicle 10 can arrive during business hours. Specifically, the controller 33 may identify a plurality of facilities at which the vehicle 10 can arrive during business hours based on positional information for the vehicle 10 and the positional information and the business hours for each facility registered in the facility database. Then, the controller 33 selects the at least two facilities from among the plurality of identified facilities.

Step S106: The controller 26 of the terminal apparatus 20 notifies the plurality of passengers of the at least two facilities selected in step S105 via the output interface 24. For example, the plurality of passengers may be notified, via a display, a speaker, or the like of the output interface 24, of information such as the name, a facility attribute, a menu, and positional information with respect to each restaurant selected in step S105, and a route and a travel time period to each restaurant selected in step S105. The controller 26 may notify, via the output interface 24, the plurality of passengers of a message prompting selection of respective desired facilities from among the at least two facilities.

Step S107: The controller 26 acquires a response from each passenger in the plurality of passengers via the input interface 25. The controller 26 notifies the server 30 of the response via the communication interface 21.

In the present embodiment, the responses from the passengers each have, for example, information indicating one or more facilities selected by a corresponding one of the passengers from among the at least two facilities notified in step S106. The selection of facilities by the passengers is performed in a voting format in which the passengers each cast a vote for a desired facility, for example, but not limited to this, and can be performed in any format.

Step S108: The controller 33 of the server 30 acquires the responses of step S107 from the terminal apparatus 20 via the communication interface 31.

Step S109: The controller 33 selects one facility from among the at least two facilities selected in step S105, based on the response from each passenger in the plurality of passengers. The controller 33 notifies the plurality of passengers of the selected one facility via the terminal apparatus 20.

Any method can be employed to select the facility. In a first example, the controller 33 may select, from among the at least two facilities, one facility with the largest count of selections made by the plurality of passengers (e.g., number of votes).

In a second example, the controller 33 may assign points to facilities selected by the passengers, and select one facility with the most points from among the at least two facilities. The controller 33 may weight points to be assigned to a facility according to which of the passengers has selected the facility. Specifically, the controller 33 acquires “relationships with other users” of each passenger in the plurality of passengers with reference to the user database stored in the memory 32. The controller 33 determines relationships among the plurality of passengers based on the “relationships with other users”. Then, in a case in which the plurality of passengers includes, for example, a “parent” and a “child”, the controller 33 may set more points to be assigned to the facility selected by the “parent” passenger than those to be assigned to the facility selected by the “child” passenger.

In a third example, the controller 33 may select one facility from among the at least two facilities, excluding a facility selected only by a particular passenger in the plurality of passengers. Specifically, the controller 33 acquires “relationships with other users” of each passenger in the plurality of passengers with reference to the user database stored in the memory 32. The controller 33 determines relationships among the plurality of passengers based on the “relationships with other users”. Then, in a case in which the plurality of passengers includes, for example, a “father”, a “mother”, and a “child”, the controller 33 determines the “child” passenger to be the particular passenger. Then, for example, in a case in which a first facility, a second facility, and a third facility have been selected by the “father” passenger, the “mother” passenger, and the “child” passenger (i.e., the particular passenger), respectively, the controller 33 selects the first facility or the second facility. The third example may be implemented in combination with the second example described above.

Step S110: The controller 26 of the terminal apparatus 20 notifies the plurality of passengers of the one facility selected in step S109 via the output interface 24. The controller 26 may notify, via the output interface 24, the plurality of passengers of a message including a proposal to make a reservation for use of the facility and to set the facility as a destination in route guidance for the vehicle 10.

Step S111: The controller 26 acquires a response from the plurality of passengers via the input interface 25. The controller 26 notifies the server 30 of the response via the communication interface 21.

In the present embodiment, the response from the passengers includes, for example, a request to make a reservation for use of the one facility selected in step S109 and to set the facility as a destination in route guidance for the vehicle 10.

Step S112: Upon acquiring the response of step S111 from the terminal apparatus 20 via the communication interface 31, the controller 33 of the server 30 makes a reservation for use of the one facility. The reservation for use may be made, for example, by coordination between the facility or a reservation service operated by a third party and the server 30.

Step S113: The controller 33 sets a destination in route guidance for the vehicle 10 to the one facility.

Step S114: The controller 26 of the terminal apparatus 20 and the controller 33 of the server 30 communicate with each other to perform the route guidance for the vehicle 10.

As described above, the server 30 of the system 1 according to the present embodiment identifies each passenger in a plurality of passengers on board the vehicle 10 based on an image of the plurality of passengers. The server 30 selects at least two facilities from among a plurality of facilities based on user attributes of each passenger in the plurality of passengers. The server 30 notifies the plurality of passengers of the at least two facilities. Then, the server 30 selects one facility from among the at least two facilities based on a response from each passenger in the plurality of passengers.

According to such a configuration, at least two facilities are selected based on user attributes such as ages and genders of a plurality of passengers from among a plurality of facilities. Thus, for example, facilities possibly preferred by the passengers, such as facilities that tend to be preferred among people who have user attributes in common with the passengers, may be selected. According to the present embodiment, one facility is selected based on responses made by the plurality of passengers upon receiving notification of the at least two facilities. Thus, for example, by each passenger voting for a desired facility, one facility for which a larger number of passengers have voted may be selected. Therefore, technology for selecting one facility from among a plurality of facilities is improved in that, for example, even in a case in which preferences for facilities differ among the plurality of passengers, one facility preferred by a larger number of passengers may be selected.

While the present disclosure has been described with reference to the drawings and examples, it should be noted that various modifications and revisions may be implemented by those skilled in the art based on the present disclosure. Accordingly, such modifications and revisions are included within the scope of the present disclosure. For example, functions or the like included in each component, each step, or the like can be rearranged without logical inconsistency, and a plurality of components, steps, or the like can be combined into one or divided.

For example, an embodiment in which the terminal apparatus 20 executes some or all of the operations that are executed by the server 30 in the embodiment described above can be implemented.

In the embodiment described above, an embodiment in which each passenger is identified using an image of a plurality of passengers on board the vehicle 10 is described. However, the identification of passengers may be performed using any information on the passengers, not limited to an image. For example, the information on the passengers may be authentication information for the passengers registered in respective terminal apparatuses 20 that are in the passengers' possession. For example, information such as a user ID and data indicating facial features of a passenger, a PIN code, or a password may be stored in advance in a memory 22 of a terminal apparatus 20 as authentication information for the passenger. The server 30 compares the authentication information received from the terminal apparatus 20 with the authentication information in the user database stored in the memory 32, and identifies the user ID of the passenger, thereby identifying the passenger.

For example, an embodiment in which a general purpose information processing apparatus functions as the terminal apparatus 20 or the server 30 according to the embodiment described above can also be implemented. Specifically, a program in which processes for realizing the functions of the terminal apparatus 20 or the server 30 according to the above-described embodiment are written may be stored in a memory of the information processing apparatus, and the program may be read and executed by a processor of the information processing apparatus. Accordingly, the present disclosure can also be implemented as a program executable by a processor, or a non-transitory computer readable medium storing the program.

1. An information processing apparatus comprising a controller configured to:
identify each passenger in a plurality of passengers on board a vehicle based on information on the plurality of passengers;
select at least two facilities from among a plurality of facilities based on user attributes indicating attributes of each passenger in the plurality of passengers;
notify the plurality of passengers of the at least two facilities; and
select one facility from among the at least two facilities based on a response from each passenger in the plurality of passengers.

2. The information processing apparatus according to claim 1, wherein the controller is configured to set a destination in route guidance for the vehicle to the one facility.

3. The information processing apparatus according to claim 1, wherein the controller is configured to make a reservation for use of the one facility.

4. The information processing apparatus according to claim 1, wherein
the controller is configured to acquire, based on the user attributes, a facility attribute indicating an attribute of a facility that matches a preference of each passenger in the plurality of passengers, and
the at least two facilities are selected based on the facility attribute from among the plurality of facilities.

5. The information processing apparatus according to claim 1, wherein
the response has information indicating one or more facilities selected by each passenger in the plurality of passengers from among the at least two facilities, and
the one facility is selected based on a count of selections made by the plurality of passengers from among the at least two facilities.

6. The information processing apparatus according to claim 5, wherein the one facility is selected from among the at least two facilities, excluding a facility selected only by a particular passenger in the plurality of passengers.

7. The information processing apparatus according to claim 6, wherein the controller is configured to determine relationships among the plurality of passengers and determine the particular passenger from among the plurality of passengers based on the relationships.

8. A method executed by an information processing apparatus, the method comprising:
identifying each passenger in a plurality of passengers on board a vehicle based on information on the plurality of passengers;
selecting at least two facilities from among a plurality of facilities based on user attributes indicating attributes of each passenger in the plurality of passengers;
notifying the plurality of passengers of the at least two facilities; and
selecting one facility from among the at least two facilities based on a response from each passenger in the plurality of passengers.

9. The method according to claim 8, further comprising setting a destination in route guidance for the vehicle to the one facility.

10. The method according to claim 8, further comprising making a reservation for use of the one facility.

11. The method according to claim 8, further comprising acquiring, based on the user attributes, a facility attribute indicating an attribute of a facility that matches a preference of each passenger in the plurality of passengers,
wherein the at least two facilities are selected based on the facility attribute from among the plurality of facilities.

12. The method according to claim 8, wherein
the response has information indicating one or more facilities selected by each passenger in the plurality of passengers from among the at least two facilities, and
the one facility is selected based on a count of selections made by the plurality of passengers from among the at least two facilities.

13. The method according to claim 12, wherein the one facility is selected from among the at least two facilities, excluding a facility selected only by a particular passenger in the plurality of passengers.

14. The method according to claim 13, further comprising determining relationships among the plurality of passengers and determining the particular passenger from among the plurality of passengers based on the relationships.

15. A system comprising:
a terminal apparatus; and
a server configured to communicate with the terminal apparatus,
wherein
the terminal apparatus is configured to transmit, to the server, information on a plurality of passengers on board a vehicle,
the server is configured to:
identify each passenger in the plurality of passengers based on the information; and
select at least two facilities from among a plurality of facilities based on user attributes indicating attributes of each passenger in the plurality of passengers,
the terminal apparatus is configured to notify the plurality of passengers of the at least two facilities, and
the terminal apparatus or the server is configured to select one facility from among the at least two facilities based on a response from each passenger in the plurality of passengers.

16. The system according to claim 15, wherein the terminal apparatus or the server is configured to set a destination in route guidance for the vehicle to the one facility.

17. The system according to claim 15, wherein the terminal apparatus or the server is configured to make a reservation for use of the one facility.

18. The system according to claim 15, wherein
the server is configured to acquire, based on the user attributes, a facility attribute indicating an attribute of a facility that matches a preference of each passenger in the plurality of passengers, and
the at least two facilities are selected based on the facility attribute from among the plurality of facilities.

19. The system according to claim 15, wherein
the response has information indicating one or more facilities selected by each passenger in the plurality of passengers from among the at least two facilities, and
the one facility is selected based on a count of selections made by the plurality of passengers from among the at least two facilities.

20. The system according to claim 19, wherein the one facility is selected from among the at least two facilities, excluding a facility selected only by a particular passenger in the plurality of passengers.
